(19) United States
(12) Patent Application Publication
(10) Pub. No.: US 2010/0289175 A1
(43) Pub. Date: Nov. 18, 2010

(54) Procedure for Extrusion of Plastic Material and Extruder

(76) Inventors: Klaus Feichtinger, Linz (AT); Gerhard Wendelin, Linz (AT); Manfred Hackl, Linz (AT); Christian Eckhart, Linz (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/738,280

(22) PCT Filed: Oct. 22, 2008
(86) PCT No.: PCT/AT08/00385

§ 371 Date: Jul. 20, 2010

(30) Foreign Application Priority Data
Oct. 22, 2007 (AT) A 1707/2007

(51) Int. Cl. B29C 47/38

(52) U.S. Cl. 264/211.21; 425/113

(57) ABSTRACT

The invention relates to a method for extruding plastic material using a screw-type extruder (S), wherein a first pressure (P₁) of the material to be extruded is measured in at least one location in the feed region (EB) of the at least one screw (2) and/or in the melting region (A) of the housing (1), the plastic material agglomerating and/or softening and being present in and not yet, in particular not completely, melted state and/or being present not yet homogeneously as a melt in said location or in said melting region. According to the invention, the material supply to the extruder (S) and/or the charge quantity is measured or controlled as a function of the measured first pressure (P1).

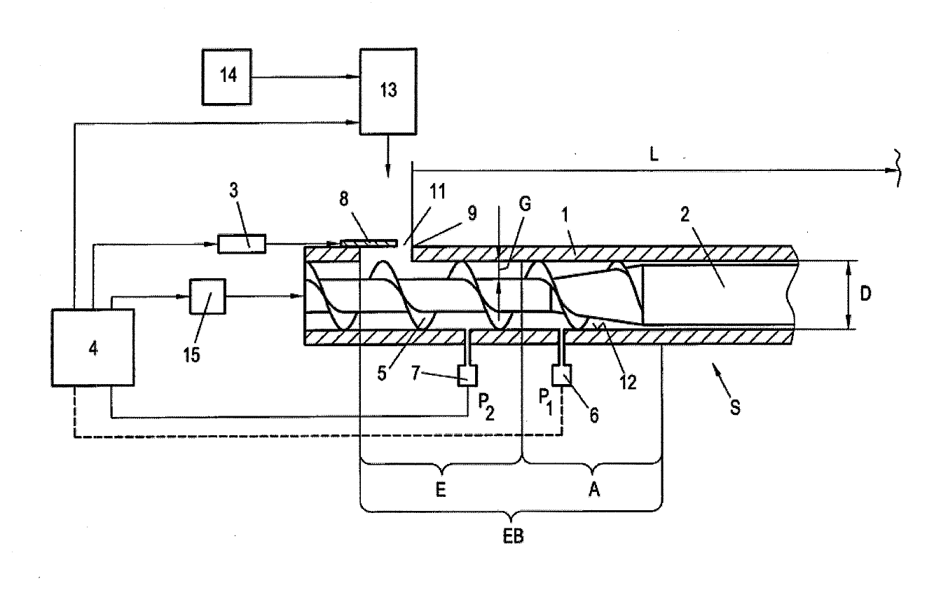

The invention relates to a procedure according to the preamble of patent claim 1 and an extruder according to the preamble of patent claim 13.

From U.S. Pat. No. 4,500,481 A, a procedure and an extruder of the type named at the outset are known. One such extruder has a plug worm gear placed ahead of it, which serves for heating of the plastic material fed to the extruder, but not for governing the charge amount. The fed plastic material is heated to achieve a more uniform extrusion, but the charge amount is not regulated in dependence on a pressure measurement signal.

In the course of regenerating refuse or production waste from plastic material, there are wide ranges within which the bulk density of the initial materials, as these are passed to a charging opening of an extruder, fluctuates greatly. For example, the bulk density with PET milled material for bottling varies between 200 kg per m³ and 600 kg per m³; with PET foils, the bulk density fluctuates from 20 kg per m³ and 300 kg per m³.

Even if the extruder has cutter compactors or reactors or preparation units placed ahead of it, the bulk density cannot in all instances be homogenized so that a uniform charging of the extruder worm gear is attained. For the design of a worm gear, or for the extruding step, the bulk density or the achieved filling ratio of the worm gear is a critically important parameter. For the most part it is not too difficult to adjust the worm gear filling ratio for a certain bulk density, and thereby attain a good extrusion result. However, it is considerably more difficult to keep the filling ratio of the worm gear constant with a variable or fluctuating bulk density, and thereby, with a defined r.p.m. of the worm gear or a desired dimension of the worm gear, to attain good extrusion results, such as for example high uniform throughput, lower melting temperature, good homogenization performance, and stable buildup of pressure in the worm gear.

From a commercial viewpoint, for certain procedures in preparing plastic materials, it is required, and able to be implemented from a technical standpoint, to use high-speed extruders that may have a relatively small worm diameter. With such units, despite the small worm diameter (smaller extruders), high mass throughputs can be obtained, and by this means a more efficient extrusion machine can be constructed. The material to be processed cannot in most cases be fed to the extruder in easy-flow granular form, and therefore here also it makes sense to take measures to have as uniform a feed of the material to the extruder worm gear as possible. It is precisely with such high-speed worm gear that it important that the plastic material to be extruded be fed in sufficient quantity, since if the worm gear is insufficiently filled, thermal or thermal-oxidative overloading of the plastic could result.

These problems are solved according to the invention with a procedure of the type named at the outset with the features presented in the characterizing part of claim 1.

According to the invention, an extruder of the type named initially is characterized by the features presented in the characterizing part of claim 10.

It has been shown that with the invention-specific procedure, the bulk density or the filling ratio of the worm gear housing or in the feed region of the extruder worm gear can be kept constant to an extent that the filling ratio of the worm gear remains constant in the range in which the plastic material to be processed is in a molten state. The selected measurement location of the first pressure signal offers the possibility to achieve exact measurement conditions.

According to the invention it is possible to regulate feed of material and/or charge amount independent of each other or adjust them to each other, by appropriately evaluating the measured pressure signals. According to the invention, different plastic materials can be processed without needing to make great demands on the type or dimensions of the worm gear. With this in turn it is possible, quickly and effectively, to melt and extrude plastic materials of differing quality and differing composition with one and the same extruder, especially if, depending on the measured pressure, the r.p.m. of at least one worm gear is dimensioned or regulated.

Along with the charge quantity, the invention-specific procedure also makes implicit allowance for the bulk density, the trickling behavior, the flowing behavior and the charging pressure KSW of the submitted plastic material.

Advantageously, a first pressure signal is measured according to the features of claim 3. This pressure measurement signal provides exact values regarding a charging requirement or the filling ratio of the worm gear. Sufficient time is available to adjust or alter the charging quantity of the worm gear housing, to compensate for falling or rising pressure, without resulting in substantial variations in temperature or pressure of the molten plastic material. This pressure signal can also be consulted to regulate the r.p.m. of the worm gear; if a pressure drop is determined, the r.p.m. of the worm gear can be reduced. Particularly through a combination of increasing the charging or lowering the worm gear r.p.m., the extrusion constancy of the molten plastic material can be further improved, especially if it is sufficiently comminuted, pre-compressed or processed.

In advantageous fashion, provision is made that a second pressure is determined at least at one location or in an area in the housing in the intake section of the worm gear, in that the worm gear has a constant core diameter and/or that the second pressure is measured at the location or in the area of the housing on which, or in which, the plastic material has a temperature that matches its Vicat temperature (T_{c})±15% T_{c} with the second pressure measurement signal being linked, if necessary following appropriate weighting, especially for making allowance for rapidly occurring changes in the charge quantity, with the first pressure measurement signal and the first and second pressure measurement signals consulted jointly for governing the charging of the extruder and/or governing the r.p.m. of the worm gear. With this a second pressure measurement signal is obtained, by which the charging can be made more precise. With this it is appropriate if the plastic material, especially plastic wastes, that are provided to the extruder for regeneration, are fed in quantity-regulated fashion from a cutter compactor or reactor or a storage container in dependence on the first pressure measurement signal and if necessary the second pressure measurement signal, and/or that before extrusion, pigments, admixture materials, fillers, fibers, softening agents and/or bleaching agents are added, or if the charge amount and/or the r.p.m. of the worm gear are regulated in dependence on the first, and if necessary, the second pressure measurement signal so that in the housing a constant filling ratio and/or a constant bulk density are attained or set, and/or if pressure is found to be dropping, the charge amount is increased and/or the r.p.m. of the extruder are reduced. If done in this way, a multitudinous spectrum of applications exists and if there is irregular charging of the extruder housing, these can quickly be detected and compensated for.

The number of places at which pressure measurement signals can be detected or recorded, is optional. If numerous sensors are available for the first or second pressure measurement value, then the measurement values emitted by the sensors can be linked in averaged or weighted fashion. Here especially, a control unit for evaluating the pressure measurement signals is also present, by which the charging unit of the extruder and/or the drive unit for the extruder worm gear is regulated. The features as per claim 8 are correspondingly advantageous.

With the invention-specific procedure, it is easily possible prior to the extrusion to add pigments, admixture materials, fillers, fibers, softening agents and/or bleaching agents to the plastic material.

In addition, what form the plastic material is in is of no concern. It can be plastic clippings, plastic foils, plastic pieces, plastic granulated material, or already processed plastic material, that, for example, is fed from a cutter compactor or reactor to the extruder.

For a simple, robust, and operationally safe design, it is advantageous if the extruder has a delivery unit for plastic material, such as a storage device or a cutter compactor or reactor placed ahead of it, and if the charging unit governed by the control unit is situated between the delivery unit and the extruder.

It is also possible that a feed screw or a cellular wheel sluice is provided as the charging unit of the extruder, the delivering amount of which is alterable using the control unit especially by governing or altering its r.p.m. in dependence on the measured first pressure. The charging unit placed between such a delivery unit and the extruder is a unit with which the release of plastic material to the extruder can be governed. It is not all that important how this governing is done; it is required that the regulation reacts well to the control signals issued by the control unit and can increase or reduce the charging of the worm gear housing relatively promptly. In a corresponding way, the drive of the worm gear should also quickly respond to the control signals issued by the control unit. For an exact regulation, it is advantageous if, when pressure is determined to be dropping, the charge quantity is increased and/or the r.p.m. of the extruder are reduced.

In what follows, the invention is explained in greater detail using the schematic drawing depicting an extruder with the appropriate attached units.

In a housing 1, an extruder worm gear 2 is supported so it can rotate. Extruder worm gear 2 has spirals that are designated by 5, and possess a corresponding spiral depth G. In the extruder housing 1, a charging opening 11 is formed, through which plastic material to be extruded can be delivered via a schematically-shown charging unit 13. The charging unit 13 has plastic material delivered to it from a delivery unit 14, such as a storage bin, a cutter condenser or a reactor. The plastic material can be fed from delivery unit 14 to charging unit 13 or from charging unit 13 to the charging opening 11 in any manner. It can be advantageous if the material removal opening of charging unit 13 is attached directly to charging opening 11.

On the inner wall of housing 1, in the feed region EB of worm gear 2, pressure sensors 6, 7 are placed, by which pressure measurement signals P₁, P₂ are collected or acquired, which are fed to a control unit 4. Depending on these pressure signals, from control unit 4 a drive unit 15 of worm gear for r.p.m. regulation of worm gear 2 and/or charging unit 13 for adjusting the amount of plastic delivered through charging opening 11 are governed.

The pressure sensors 6, 7 are situated in the area EB or on the inner wall surface 12 of housing 1, to measure the pressure exerted by the material released from charging unit 13 or of the material to be extruded on inner wall 12 of housing 1.

A first pressure P₁ is measured at least at a location or in an area A of housing 1, at which or in which the plastic material agglomerates or softens, and still has not melted, or especially not completely, or is not yet homogeneously present as a melt, i.e. in advantageous fashion at the start of melting area A. The first pressure P₁ is thus determined in area A of housing 1, in which the core diameter D of worm gear 2 starts to increase or the spiral depth G of worm gear 2 starts to reduce.

It is advantageous if at least one second pressure measurement unit 7 is placed at a location or in an area E of housing 1 in which worm gear 2 has a constant core diameter D.

In practice it has been shown that it is appropriate if the second pressure P₂ is measured at the location or in the area E of housing 1 at which, or in which, the plastic material has a temperature in the range that is prescribed by the Vicat temperature (T_{c}±15% T_{c}.

As pressure measurement units, sensors are used that can cope with the temperatures present and any possible pressure spikes, especially piezoelectric, piezorestrictive systems or systems based on wire strain gauges.

The measured first pressure measurement signal P₁ recognizes whether the fed plastic material in feed region A of worm gear 2 has already achieved the appropriate consistency, i.e., has almost, but not completely, melted or is not yet fully homogenized. Determination of the pressure in this area provides exact signal information regarding the filling ratio of feed region EB of worm gear 2 and the worm gear 2 itself. The signal of pressure measurement unit 6 placed in melting area A is thus consulted as an essential regulating signal for charging unit 13 or drive 15 of extruder worm gear 2.

In supplementary fashion, second pressure measurement signal P₂ can be consulted, which in regard to the fluctuating bulk density or a fluctuating filling ratio, can change relatively quickly, and therefore can be linked with first pressure measurement signal P₁ in control unit 4.

It is appropriate if control unit 4 has a regulator, especially a PID regulator, which governs charging unit 13 or drive 15.

For exact regulation, it is advantageous, especially for extrusion of polyolefins, if first measurement signal P₁ is measured in a range of L=(1 to 16) D, preferably L=(4 to 10) D, from the location at which the spiral depth G of worm gear 2 starts to be reduced, and/or that second measurement signal P₂ is measured in an interval range from L32 (0.1 to 10) D, especially L=(0.5 to 5) D, from the downstream edge 9 of charging opening 11, or that during extrusion of partially crystalline materials with a high energy content such as polyamines, the first pressure measurement signal P₁ is measured at an interval or range of L−(1 to 20) D, especially (5 to 15) D, from downstream edge 9 of charging opening 11.

The length L is measured based on the downstream edge 9 of charging opening 11. It has been shown that the placement of pressure measurement unit 7 in this area permits the charging of the inserted plastic materials delivered through the spirals 5 of the worm gear to be well homogenized, since these signals permit recognition of a tendency toward excessively high or excessively low charging of worm gear housing 1. The pressure measurement unit is situated accordingly.

Especially the second pressure measurement signal P₂ is consulted for a timely analysis, or emergency measures could also be introduced that become necessary if the filling ratio in the feed region of worm gear 2 is viewed as insufficient. Second pressure measurement signal P₂ quickly provides a signal in regard to an inhomogeneous charging, since alterations in the bulk density of the submitted plastic material can be well and speedily detected by this pressure measurement unit.

The charging unit 13 can be of whatever type. Provision can be made that charging unit 13 includes a shutoff unit, especially a slider 8 able to be adjusted by an actuator or motor, or an adjustable cover, with which the cross section of charging opening 11 or a filling sleeve can be altered depending on the pressure measurement signals P₁, P₂ supplied from control unit 4, as this is depicted by way of example in the drawing.

Provision can further be made that a feed screw or a cellular wheel sluice can be provided as the charging unit 13 of extruder S, the delivery amount of which is especially alterable by controlling or altering their r.p.m. via control unit 4.

To obtain a precise release of plastic material from charging unit 13, if a slider is doing the controlling, the position of the slider is measures by electronic path measurement or electronic measurement of the slide's position, to exactly adjust the passage opening. The same holds true for controls of cellular wheel sluices, the opening and closing of which can be appropriately monitored or controlled.

After an appropriate pre-processing such as filtering, the measured pressure signals P₁, P₂ can be passed to control unit 4 or to the PID regulator.

It has been shown that when using the invention-specific procedure, charging or throughput of plastic material or its extrusion via a traditional extruder are increased vis-à-vis previous throughputs, since the worm gear can be charged more evenly and always with a sufficiently high charging ratio. By this means the r.p.m. of the worm gear could be increased and the throughput of the extruder could be brought up. This procedure is especially well suited for preparation of relatively clean plastic materials that are delivered in the form of flakes.

In principle it is possible to use the invention-specific procedure also with extruders having multiple worm gears or dual-worm-gear extruders.

1-15. (canceled)

16: Procedure for extrusion of plastic material with a worm-gear extruder (S) having at least one worm gear (2), with a first pressure (P₁) of the material to be extruded being measured at at least one location in the melt area (A) of the housing (1) in which melt area the plastic material softens and is still not melted, or not completely, and is still not homogeneously present as a melt, characterized in that in dependence on the measured first pressure (P₁), the charging amount of the extruder (S) is regulated.

17: Procedure according to claim 16, characterized in that in dependence on the measured first pressure (P1), the r.p.m. of the at least one worm gear (2) are dimensioned or regulated.

18: Procedure according to claim 16, characterized in that the first pressure (P₁) is determined in an area (A) of the housing (1) in which the core diameter (D) of the worm gear (2) starts to increase and/or the channel depth (G) of the worm gear (2) begins to decrease.

19: Procedure according to claim 16, characterized in that a second pressure (P₂) is determined at at least one location or in one area in the housing (1) in the intake area (E) of the worm gear (2), in which the worm gear (2) has a constant core diameter (D) and/or that the second pressure (P₂) is measured at the location or in the area (E) of the housing (1) at which or in which the plastic material has a temperature that corresponds to its Vicat temperature (T_{c})±15% Tₑ where if necessary, after appropriate weighting, especially to allow for rapid changes in the charging quantity if necessary, the second pressure measurement signal (P₂) is linked with the first pressure measurement signal (P₁) and the first and second pressure measurement signals are jointly consulted for regulating the charging of the extruder (S) and/or for governing the r.p.m. of the worm gear (2).

20: Procedure according to claim 16, characterized in that the pressure (P₁, P₂) exerted by the material to be extruded on the inner wall of the housing (1) is measured, with the pressure (P₁, P₂) being measured in the close range of, or on, the surface (12) of the inner wall of the housing.

21: Procedure according to claim 16, characterized in that the extruder (S) for regeneration of provided plastic material, especially plastic wastes, is fed from a cutter compactor or reactor (R) or a storage container in dependence on the first pressure measurement signal (P₁) and if necessary on the second pressure measurement signal (P₂) in quantity-regulated fashion, and/or that pigments, admixture materials, fillers, fibers, softeners and/or bleaching agents are added prior to the extrusion.

22: Procedure according to claim 16, characterized in that the charging amount and/or the r.p.m. of the worm gear (2) are governed in dependence on the first and if necessary on the second pressure measurement signal (P₁, P₂), so that in the housing (1) a constant filling ratio and/or a constant bulk density are attained or set and/or if pressure (P₁, P₂) is determined to be dropping, the charging amount is increased and/or the r.p.m. of the extruder (S) are reduced.

23: Procedure according to claim 16, characterized in that the first pressure measurement signal (P₁) is passed if necessary via a regulator to control unit (4), by which a charging unit (13) or a regulating actuator or an adjusting motor (3) is governed.

24: Procedure according to claim 16, characterized in that especially with extrusion of polyolefins, the first pressure measurement signal (P₁) is measured in a distance range of L=(1 to 16) D, preferably L=(4 to 10) D, from the location at which the channel depth (G) of the worm gear (2) begins to be reduced, and/or that the second pressure measurement signal (P₂) is measured at a distance range of L=(0.1 to 10) D, especially L =(0.5 to 5) D, from the downstream edge (9) of the charging opening (11), or that during extrusion of partially crystalline materials with a high energy content such as polyamides, the first pressure measurement signal (P₁) is measured at a distance or a range of L=(1 to 20) D, especially (5 to 15) D, from the downstream edge (9) of the charging opening (11).

25: Extruder for plastic material with at least one worm gear (2) rotating in a housing (1) with a charging opening (11) emptying from above or laterally into the housing for materials delivery, especially for carrying out the procedure according to claim 16, with at least one pressure measurement unit (6, 7) being situated in the intake area (EB) of the worm gear (2) for determination of a first pressure exerted by the delivered material in the housing (1) with the first pressure measurement unit (6) being situated at a location or in an area (A) of the housing (1) on which or in which the plastic material agglomerates and/or softens and has not yet melted, or not completely, and/or is not yet homogeneously present as a melt, and with the pressure measurement signals being fed to a control unit (4), characterized in that the control unit (4) in dependence on pressure measurement signals (P₁) regulates a charging unit (13) of the extruder or the charging amount of the worm gear (2).

26: Extruder according to claim 25, characterized in that the first pressure measurement unit (6) is situated in an area (A) of the worm gear (2) in which the core diameter (D) of the worm gear (2) begins to expand and/or the channel depth (G) of the worm gear (2) begins to be reduced.

27: Extruder according to claim 25, characterized in that at least a second pressure measurement unit (7) is situated at a location or in an area (E) of the housing (1) downstream of the charging opening (11), in which the worm gear (2) has a constant core diameter (D) and/or at which location or in which area the plastic material has a temperature that matches its Vicat temperature (T_{c})+15% T_{c}.

28. Extruder according to claim 25, characterized in that the pressure measurement unit(s) (6, 7) is or are situated in the area of, or at, the inner wall surface (12) of the housing (1) and/or that the particular pressure measurement devices (6, 7) are attached to a control unit (4), by which a provided charging unit (13) of the extruder (S) and if necessary a provided drive unit (15) of the worm gear (2) can be governed and/or that the pressure measurement signals (P₁, P₂) of the pressure measurement devices (6, 7) are fed to a control unit (4) which is attached to the drive unit (15) or the motor of the extruder worm gear (2) and that governs the r.p.m. of the drive unit (15) or of the motor.

29: Extruder according to claim 25, characterized in that especially for extrusion of partially crystalline materials with a high energy content such as polyamides, the first pressure measurement unit (6) is situated in a distance range of L=(1 to 20) D, especially L=(5 to 15) D, from the downstream edge (9) of the charging opening (11), or that especially for the extrusion of polyolefins, the first pressure measurement unit (6) is situated at a distance range of L=(1 to 16) D, especially L=(4 to 10) D, from the downstream edge of the charging opening (11) and/or that the second pressure measurement unit (7) is situated in a distance range L=(0.1 to 10) D, especially L=(0.5 to 5) D, from the downstream edge (9) of the charging opening (11).

30: Extruder according to claim 25, characterized in that the extruder (S) has a delivery unit (14) for plastic material such as a storage bin or a cutter compactor or reactor placed ahead of it, and that between the delivery unit (14) and the extruder (S), the charging unit (13) governed by the control unit (4) is placed, and/or the charging unit (13) includes a shutoff unit, especially a slider (8) able to be adjusted by an actuator or motor (3) or an adjustable cover by which the cross section of the charging opening (11) or of a filling sleeve can be altered in dependence on pressure measurement signals supplied by the control unit (4) and/or that a feed screw or a cellular wheel sluice are provided as the charging unit (13) of the extruder (S), whose delivery quantity can be altered especially by controlling or changing their r.p.m. via the control unit (4), and/or that a material delivery line of the charging unit (13) is attached directly to the charging opening (11) of the housing (1) of the worm gear (2).
